(19) United States
(12) Patent Application Publication
(10) Pub. No.: US 2025/0373557 A1
(43) Pub. Date: Dec. 4, 2025

(54) DITHERING OF RECOVERED SIGNAL

(71) Applicant: TEXAS INSTRUMENTS INCORPORATED, Dallas, TX (US)

(72) Inventors: Kalpesh Laxmanbhai RAJAI, Bangalore (IN); Raghu GANESAN, Bangalore (IN); Manoj KATTA VENKATA, Bangalore (IN); Ravi ARIPIRALA, Bangalore (IN)

(21) Appl. No.: 19/224,739

(22) Filed: May 31, 2025

(30) Foreign Application Priority Data
Jun. 3, 2024 (IN) 202441043147

(51) Int. Cl. H04L 47/22; H04L 47/24; H04L 47/283

(52) U.S. Cl. CPC H04L 47/22; H04L 47/24; H04L 47/283

(57) ABSTRACT

In an embodiment, an apparatus includes: a transmitting data path configured to transmit an outgoing data packet; and a receiving data path configured to receive an incoming data packet; a controller configured to determine timing information of the incoming data packet; and dithering circuitry configured to dither a reference signal according to the timing information to vary a frequency of the signal over time to generate a dithered recovered signal.

### CROSS-REFERENCE TO RELATED APPLICATIONS

The present disclosure claims priority to India Provisional Patent Application No. 202441043147, which was filed Jun. 3, 2024, is titled “DITHERING METHODS FOR ETHERNET PHYS,” and is hereby incorporated herein by reference in its entirety.

### TECHNICAL FIELD OF THE INVENTION

The present disclosure relates generally to an electronic system and method, and, in particular embodiments, to dithering of a recovered signal.

### BACKGROUND

Ethernet is a family of networking technologies that transmits data over physical media within various network types. The Ethernet standard defines protocols and specifications for the physical layer (PHY) and data link layer of the Open Systems Interconnection (OSI) model, including electrical signaling methods, frame formats, hardware addressing, and medium access control (MAC) procedures. Ethernet systems operate over copper cables, optical fiber, or wireless communication links, using defined data transmission rates and line encoding techniques. The Ethernet protocol includes functions for error detection, collision management, and support for full-duplex and half-duplex communication modes. Ethernet is defined by the Institute of Electrical and Electronics Engineers (IEEE) standard 802.3 and supports a range of network speeds and topologies.

### SUMMARY

In accordance to an embodiment, an apparatus includes: a transmitting data path configured to transmit an outgoing data packet; and a receiving data path configured to receive an incoming data packet; a controller configured to determine timing information of the incoming data packet; and dithering circuitry configured to dither a reference signal according to the timing information to vary a frequency of the signal over time to generate a dithered recovered signal.

In accordance to an embodiment, an integrated circuit includes: a receiving data path configured to receive an incoming data packet; a first phase interpolator configured to generate a recovered clock signal based on a reference signal and according to timing information derived from the incoming data packet; an analog-to-digital converter (ADC) configured to operate based on the recovered clock signal; a second phase interpolator configured to dither the reference signal to generate a dithered clock signal; and a digital core configured to operate based on the dithered clock signal.

In accordance to an embodiment, a method includes: receiving an incoming data packet on a receiving data path; determining a dither control signal based on timing information of the incoming data packet; dithering a reference signal according to the dither control signal to form a dithered recovered signal; and processing the dithered recovered signal.

In accordance to an embodiment, an apparatus includes: a transmitting data path configured to transmit an outgoing network packet; and a receiving data path configured to receive an incoming network packet; and a controller configured to: dither a clock signal to vary a frequency of the clock signal over time to generate a dithered clock signal, and modulate one or more properties of the clock signal to synchronize the incoming and outgoing network packets.

In accordance to an embodiment, an integrated circuit includes: a receiving data path configured to receive an incoming network packet; a first phase interpolator configured to generate a recovered clock signal; an analog-to-digital converter (ADC) configured to operate based on the recovered clock signal; a second phase interpolator configured to dither the clock signal to generate a dithered clock signal; and a digital core configured to operate based on the dithered clock signal.

In accordance to an embodiment, a method including: transmitting an outgoing network packet on a transmitting data path; and receiving an incoming network packet data path on a receiving data path; dithering a clock signal to vary a frequency of the clock signal over time; and modulating one or more properties of the clock signal to synchronize the incoming and outgoing network packets.

In accordance to an embodiment, a computer program product including a computer-readable storage medium having computer-readable program code embodied therewith, the computer-readable program code configured to be executed by a controller configured to: transmit an outgoing network packet on a transmitting data path; receive an incoming network packet data path on a receiving data path; dither a clock signal to vary a frequency of the clock signal over time; and modulate one or more properties of the clock signal to synchronize the incoming and outgoing network packets.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a block diagram of an electronic system including an Ethernet receiver capable of signal dithering and/or duty cycle modulation to suppress RFI emission by the Ethernet receiver, in accordance with various examples;

FIG. 2 is a block diagram of the PHY layer, in accordance with various examples;

FIG. 3 is a block diagram of dithering circuitry, in accordance with various examples;

FIG. 5 is a block diagram of dithering circuitry, in accordance with various examples;

FIG. 5 is a block diagram of dithering circuitry, in accordance with various examples;

FIG. 6 is a block diagram of dithering circuitry, in accordance with various examples;

FIG. 7 is a block diagram of dithering circuitry, in accordance with various examples;

FIGS. 8A and 8B are graphs of performance of the dithering circuitry, in accordance with various examples;

FIG. 9 is a graph of performance of the dithering circuitry, in accordance with various examples;

FIG. 10 is a graph of performance of the dithering circuitry, in accordance with various examples; and

FIG. 11 is a flow diagram of a method of RFI mitigation, in accordance with various examples.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” or “in one example” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Some embodiments relate to radio frequency interference mitigation in electronic communications.

Some embodiments relate to dithering of a recovered clock signal.

Ethernet is useful in a wide range of applications. Generally, Ethernet implementations are expected to provide high reliability, even in challenging conditions. For example, Ethernet is frequently implemented in safety and infotainment features in vehicles, aircraft, and spacecraft and must perform with a high degree of reliability despite radio frequency interference (RFI) that may originate from switching power electronics, electric motors and controllers, ignition systems, wireless systems in the vehicle (e.g., BLUETOOTH, cellular, WI-FI), and so on. For example, regulatory bodies, industry standard bodies, or the like may provide emissions standards against which electrical components may be judged for compliance. Compliance, or lack of compliance, with these standards may determine whether an electrical component is suitable for a particular application environment. Therefore, in the context of Ethernet, an electrical component, such as a device implementing an Ethernet PHY, should be compliant with both the relevant emissions standards for a particular application environment, as well as communication standards for communicating with other components, such as an electrical component implementing a media access control (MAC) layer.

Although some embodiments are described within the specific context of Ethernet, the teachings of this disclosure may be more generally applicable and are not limited to an Ethernet application environment. For example, the teachings of this disclosure may be applicable to other communication protocols, standards, or techniques beyond the scope of Ethernet. For example, the teachings of this disclosure may be application to other application environments that include wireline transceivers such as Universal Serial Bus (USB) or (Peripheral Component Interconnect Express (PCIe), as well as application environments that include wireless transceivers, such as in a wireless local area network (WLAN), BLUETOOTH environment, Global Positioning Satellite (GPS) system, cellular system, etc.

At least some communication protocols, including Ethernet, communicate according to standardized processes. Among other benefits, this facilitates interoperability between electrical components provided by different sources. These standards may specify a clock rate for transmitting communication, a size for units of data (e.g., packets, frames, etc.) of the communication, or any other suitable characteristic. On a transmitting end of a communication path, a device may receive data from a host for communication and may encode that data into one or more symbols. Generally, a symbol is a pattern that is known to both transmitter and receiver in a communication path and allows for one symbol to be distinguished from another.

The transmitter may operate according to multiple different clock frequencies. For example, a host interface of the transmitter may communicate with a device operating in a MAC layer at a first frequency. The transmitter may also include digital switching circuitry that operates at a second frequency to encode symbols for transmission by the transmitter and/or decode received symbols. Signal switching occurring at the first and second frequencies may be sources of RFI, among other potential sources. Various techniques for RFI mitigation exist. However, many of these techniques that may mitigate RFI may also make the components implementing the techniques non-compliant with relevant standards, such as those promulgated by IEEE. As such, challenges may exist in mitigating RFI while also maintaining compliance with relevant communication standards.

One approach for mitigating RFI is dithering. Dithering is a technique in which the creation of RFI at a particular frequency is mitigated. For example, the frequency (clock frequency, switching frequency, etc.) of a device is modulated within a range of a nominal value for the frequency. For example, a 25-megahertz (MHz) clock signal for controlling operation of a device may be modulated within a range of 25 MHz+/−N Hz, where N is any suitable positive value. This modulation reduces a peak intensity of RFI emitted by the device at approximately 25 MHz, instead spreading the RFI across a range of frequencies (e.g., sideband frequencies) surrounding 25 MHz. In this way, the RFI at any one frequency within that range may be reduced, thereby enabling the device to meet various RFI emissions standards. However, further challenges may exist in implementing dithering in a device which must also be compliant with communication standards, such as Ethernet.

For example, a data path of a receiving device in Ethernet communication may operate according to a clock signal recovered from communication received from a transmitting device. In such examples, it may be beneficial for a dithered clock signal to have an average frequency approximately equal to a frequency of the recovered clock signal. Additionally, a clock signal according to which a transmitted communicates with a host or data source may also need to meet timing specification defined by a communication standard despite the use of a dithered clock signal to mitigate RFI. Still further, in time synchronized networks, the accuracy of synchronization depends on the network latency and may be impacted by jitter in the latency. When timestamping is implemented in the PHY and a data path of the PHY operates according to a dithered clock signal, additional jitter may be introduced in the timestamping, degrading he synchronization accuracy.

Some embodiments mitigate technical challenges associated with RFI emission by transceivers, such as an Ethernet PHY. In some examples, a signal may be dithered to distribute electromagnetic energy from having a peak at a nominal frequency of the signal to a range of frequencies having an average frequency approximately equal to the nominal frequency. This distribution of electromagnetic energy may increase a noise base of the signal within the range of frequencies (e.g., increase overall noise present in the range of frequencies, and therefore RFI emitted at frequencies within the range of frequencies) while reducing a peak amplitude of the noise and RFI at the nominal frequency. In this way, the RFI emitted at the nominal frequency may be reduced, such as below an RFI threshold specified by a relevant specification or standard, while increasing RFI emitted at frequencies within the range of frequencies, while still maintaining the RFI at the range of frequencies beneath the same RFI threshold. In some examples, the dithering is performed by controlling a phase interpolator to modulate a frequency of the signal. The modulation may be controlled, in some examples, by a dither controller.

In some examples, the RFI of the signal may be further reduced through additional techniques. For example, many signals implemented as clock signals have a 50% duty cycle. In such signals, the dithering may concentrate the RFI at one of odd or even harmonics of the nominal frequency. By modulating the duty cycle of the signal in a range of duty cycles having an average equal to a nominal duty cycle, the RFI associated with the signal may be advantageously further reduced. For example, the RFI may be distributed across both odd and even harmonics within the range of frequencies by modulating the duty cycle.

In some examples, the duty cycle is modulated according to a divide control signal. The divide control signal may have a constant (e.g., fixed) value, or may have a random value. In examples in which the divide control signal has a random value, the random value may be determined according to any suitable process, the scope of which is not limited herein. In an example, the random value is determined according to a linear-feedback shift register (LFSR). In another example, the random number is determined according to a Galois Field polynomial, such as a 3-stage Galois Field polynomial. The polynomial may be of any suitable order, where a higher polynomial order may result in a reduced peak RFI compared to a lower polynomial order, but may also result in greater drift of the average frequency of the dithered signal from the nominal frequency. In some examples, a plurality of cascaded polynomials having an order between the higher polynomial order and the lower polynomial order may be used to both result in a reduced peak RFI compared to the lower polynomial order while reducing the drift of the average frequency of the dithered signal from the nominal frequency compared to the higher polynomial order.

In some examples, the modulation of the duty cycle is performed by modulating a division circuit which divides the dithered signal to form a divided dithered signal. In other examples, the modulation of the duty cycle is performed by modulating the dither controller which controls the phase interpolator. In still other examples, the phase interpolator performing the dithering is a first phase interpolator and the modulation of the duty cycle is performed by modulating a second phase interpolator coupled to an output of the first phase interpolator (e.g., such as coupled between the output of the first phase interpolator and an input of the divider circuit).

Based on one or more of these techniques for dithering and/or modulating a duty cycle of a signal in an Ethernet PHY, RFI of the Ethernet PHY may be advantageously reduced compared to similar systems lacking the dithering and/or modulation. In this way, the Ethernet PHY and system including the dithering and/or modulation may be advantageously improved compared to an Ethernet PHY and system lacking the dithering and/or modulation. In some embodiments, this improvement manifests in a reduced level of RFI emission of the Ethernet PHY and system including the dithering and/or modulation. In some examples, the improvement further, or alternatively, manifests in a reduced level of variance of a dithered signal frequency of the Ethernet PHY and system including the dithering and/or modulation from a nominal signal frequency.

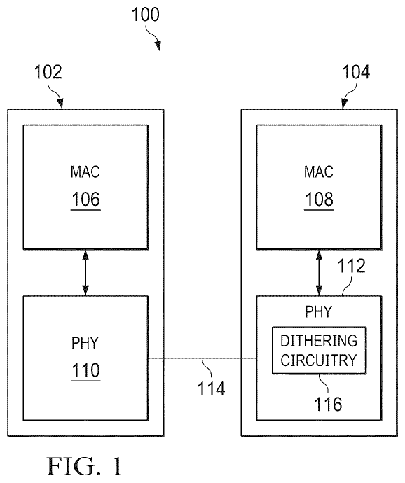

FIG. 1 is a block diagram of an electronic system including an Ethernet receiver capable of signal dithering and/or duty cycle modulation to suppress RFI emission by the Ethernet receiver, in accordance with various examples. While described herein as a receiver, in some examples the teachings may be equally applicable to a component having both transmitter and receiver capability, such as a transceiver. In particular, FIG. 1 is a block diagram of an electronic system 100 that includes electronic control units (ECUs) 102 and 104, which, in turn, include media access control (MAC) layers 106 and 108, respectively. The ECU 102 includes a PHY layer transmitter (“transmitter”) 110, and the ECU 104 includes a PHY layer receiver (“receiver”) 112. The transmitter 110 interfaces with the MAC layer 106, and the receiver 112 interfaces with the MAC layer 108. The transmitter 110 and the receiver 112 are referred to herein as “transmitter” and “receiver” because the flow of data for purposes of description is assumed to be from the transmitter 110 to the receiver 112. In practice, the transmitter 110 and the receiver 112 may be transceivers permitting bidirectional data flow. A cable (e.g., a differential signal cable), or more generally a transmission medium, 114 couples the PHY layer transmitter 110 to the PHY layer receiver 112, as shown. While described herein as MAC layers, either or both of the MAC layers 106, 108 may be generally representative of any host device, circuit, component, or the like that provides data to, or receives data from, the PHY layers 110, 112, respectively.

The electronic system 100 may be any type of apparatus or system in which Ethernet communications are implemented. Examples of the electronic system 100 include desktop computers, laptops, network switches, routers, wireless access points, printers, servers, storage arrays, smart televisions (TVs), game consoles, streaming devices, set-top boxes for home entertainment and connectivity, programmable logic controllers (PLCs), human-machine interfaces (HMIs), sensors, actuators, robotic systems, automotive infotainment systems, automotive cameras, radar units, VoIP phones, security cameras, medical imaging systems, telecommunications equipment, building automation controllers, and so on.

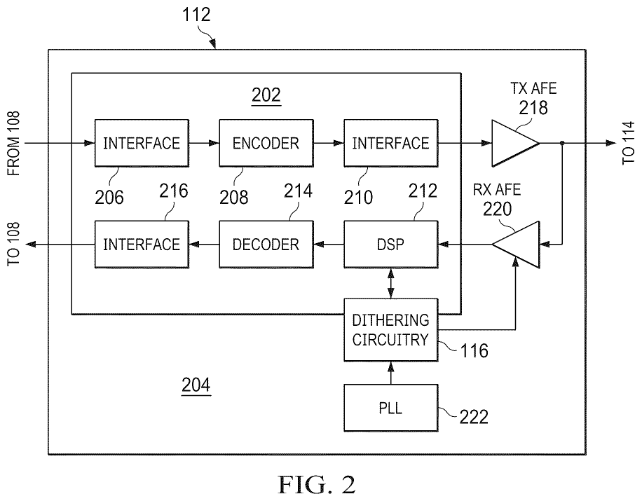

As described in detail below, the PHY layer 112, and more specifically, the receiver (or transceiver) implementing the PHY layer 112, is capable of signal dithering and/or duty cycle modulation to suppress RFI emission by the ECU 104. For example, the PHY layer 112 includes dithering circuitry 116 for dithering and/or duty cycle modulation to suppress RFI emission by the ECU 104. Although shown and described as a component of the PHY layer 112, the PHY later 110 may also include dithering circuitry substantially similar to the dithering circuitry 116. FIGS. 2-6 are now described to present various embodiments of the PHY layer 112 and dithering circuitry 116, in accordance with various examples.

In some embodiments, each of devices 102 and 104 may be implemented in a respective single integrated circuit (IC). In some embodiments, each of devices 102 and 104 may be implemented with a plurality of respective ICs.

In some embodiments, MAC 108 may be implemented as part of a host processor or controller that is separate from the PHY layer 112. In some embodiments, MAC 108 and PHY 112 are implemented as part of the same processor or controller. In some embodiments, MAC 106 may be implemented as part of a host processor or controller that is separate from the PHY 110. In some embodiments, MAC 106 and PHY 110 are implemented as part of the same processor or controller. Other implementations may also be possible.

FIG. 2 is a block diagram of the PHY layer 112, in accordance with various examples. In an example, the PHY layer 112 include a digital portion 202 and an analog portion 204. The dithering circuitry 116 may be implemented at least partially in the digital portion 202 and partially in the analog portion 204. In an example, the digital portion 202 of the PHY layer 112 also includes an interface 206, an encoder 208, an interface 210, a digital signal processor (DSP) 212, a decoder 214, and an interface 216. In an example, the analog portion 204 of the PHY later 112 also includes a transmitter (TX) analog front end 218, a receiver (RX) analog front end 220, and a phase-locked loop (PLL) 222.

In an example, the interface 206 and the interface 216 are each an interface suitable for translating data or otherwise interfacing between the PHY layer 112 and the MAC layer 108, the scope of which is not limited herein. In the context of Ethernet, the interface 206 and the interface 216 may each be a media-independent interface (xMII). In an example, the encoder 208 is suitable for performing tasks such as data encoding, scrambling, alignment marker insertion, etc., the scope of which is not limited herein. In the context of Ethernet, the encoder 208 may be a physical coding sublayer (PCS). In an example, the interface 210 is suitable for interfacing between the digital portion 202 and the analog portion 204 of the PHY layer 112, the scope of which is not limited herein. In some examples, the interface 210 is referred to as an analog front end (AFE). In the context of Ethernet, the interface 210 may be a physical media attachment (PMA) sublayer.

The DSP 212 may be any suitable component or components suitable for performing digital processing, the scope of which is not limited herein. In some examples, the DSP 212 is a standalone component. In other examples, any one or more components of the digital portion 202 of the PHY layer 112, such as the DSP 212, are components of a digital core. In some examples, at least some components of the digital core operate based on a value of a dithered signal provided by the dithering circuitry 116, such as a dithered recovered signal and/or a divided dithered signal. The digital core may be the portion of the PHY layer 112 that handles digital logic and processing, as opposed to analog or other specialized functions. The digital core may implement various function or provide functionality based on programming. For example, functionality may be specified in the digital core according to register-transfer level (RTL). In an example, RTL is a design abstraction that models a digital circuit in terms of data or signal flow between hardware registers in terms of the logical (e.g., digital) operations performed on that data or those signals. Thus, a digital circuit may be synthesized by defining its inputs, outputs, and function in code without implementing the digital circuit in dedicated discrete, physical components. In an example, the decoder 214 is suitable for performing tasks such as data decoding, descrambling, etc., the scope of which is not limited herein. In the context of Ethernet, the encoder 208 may be a PCS.

The TX AFE 218 and the RX AFE 220 may each be suitable for translating data between digital and analog domains, the scope of which is not limited herein. In some examples, at least some components of the analog portion 404, such as the TX AFE 218 and/or the RX AFE 220, operate based on a value of a recovered signal provided by the dithering circuitry 116. In one example (not shown), the TX AFE 218 includes a digital-to-analog converter (DAC) for converting data from a digital to an analog domain for transmission via the cable 114, a filter for anti-aliasing, to reject noise, etc., an amplifier for driving a signal on the cable 114, or the like. In one example (not shown), the RC AFE 220 includes an analog-to-digital converter (ADC) for converting data from the analog to the digital domain for, a filter for anti-aliasing, to reject noise, etc., an amplifier, or the like. Generally, the content of the TX AFE 218 and the RX AFE 220 are not limited herein and may be determined according to a use case of the PHY layer 112. In an example, the interface 206, encoder 208, interface 210, and TX AFE 218 form a transmit (or transmitting) data path of the PHY layer 112. Similarly, the RX AFE 220, the DSP 212, the decoder 214, and the interface 216 form a receive (or receiving) data path of the PHY layer 112.

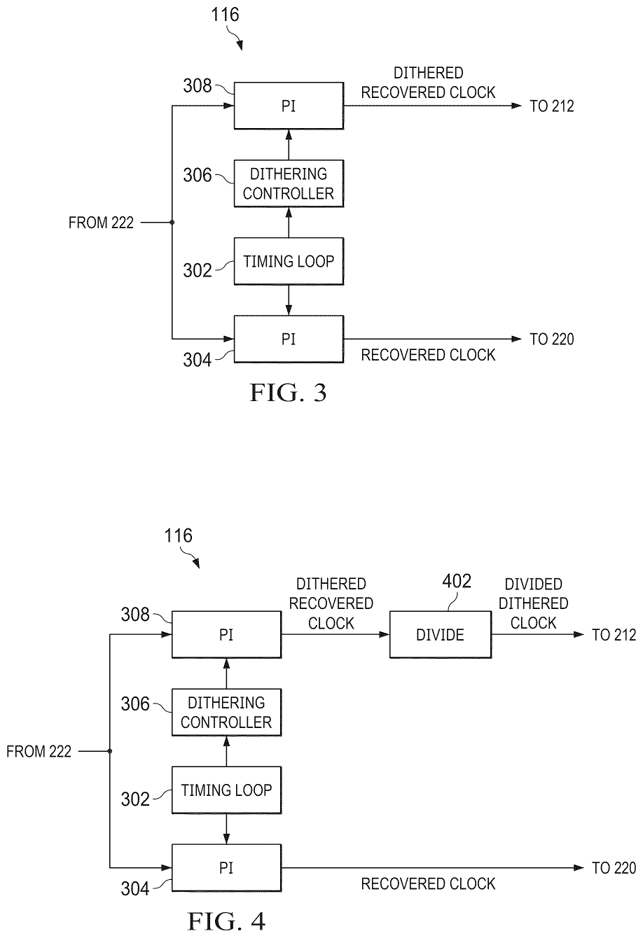

FIG. 3 is a block diagram of dithering circuitry 116, in accordance with various examples. In the example of FIG. 3, the dithering circuitry 116 includes a timing loop 302, a phase interpolator 304, a dithering controller 306, and a phase interpolator 308. In some examples, the phase interpolator 304 and the phase interpolator 308 are each implemented in the analog portion 204 of the PHY layer 112, the timing loop 302 is implemented in the DSP 212, and the dithering controller 306 is implemented in the digital portion 202 of the PHY layer 112. The timing loop 302, phase interpolator 304, and phase interpolator 308 may be implemented according to any suitable process and/or architecture, the scope of which is not limited herein. In some examples, the dithering controller 306 is implemented according to RTL code implementable by the digital portion 202 of the PHY layer 112 to perform digital operations. In this way, in some embodiments, the dithering controller 206 may be considered a form of synthesized digital logic.

In an example of operation, the timing loop 302 controls the PI 304 to generate a recovered signal based on a reference output of the PLL 222 and a signal received at the DSP 212 (such as from the PHY layer 210). For example, the timing loop 302 derives a timing error from the signal received at the DSP 212 (“received symbols”). The timing loop 302 may derive the timing error from the received symbols according to any suitable process, the scope of which is not limited herein. In an example, the timing loop 302 implements a Mueller & Muller process for deriving the timing error. Based on the control of the timing loop 302, the PI 304 provides a recovered signal. In an example, the recovered signal has a frequency determined according to the signal received by the DSP 212. In this way, the output signal of the PI 304 (e.g., the recovered signal) is said to be recovered from the signal received at the DSP 212. In some examples, the PI 304 provides the recovered signal to one or more components of the analog portion 204, such as the RX AFE 220, for clocking the component(s).

In some embodiments, the recovered clock may be used by one or more circuits of receiver 112, such as RX AFE 220 (e.g., as a sampling clock for an ADC of RX AFE 220).

The timing loop 302 further controls the dithering controller 306. Based on the control of the timing loop 302, dithering controller 306 controls the PI 308 to provides a dithered recovered signal. In some examples, the dithered recovered signal (or a signal further derived from the dithered recovered signal, such as a divided dithered signal) is provided to one or more components of the digital portion 202 for clocking the component(s). In various examples, the PI 304 and the PI 308 may be controlled to perform modulation according to any suitable scheme such as triangular modulation, sawtooth modulation, or the like, the scope of which is not limited herein. In some examples, each of the PI 304 and the PI 308 receive phase update signals that cause the respective PI to shift the phase of the output signal it provides by a particular amount in a particular direction, as specified in the phase update signal(s).

For example, the dithering controller 306 receives a dither control signal from the timing loop 302 (e.g., a component of the DSP 212) that specifies a phase shift. Based on the dither control signal, the phase interpolator 308 modifies a phase of a signal received from the PLL 222 at a first frequency to generate a dithered recovered signal having an average frequency approximately equal to the frequency of the recovered signal. Although described herein as a singular signal, the dithered recovered signal may be a plurality of signals at frequencies within a range of the frequency of the recovered signal, where an average of the frequences of the plurality of signals is approximately equal to the frequency of the recovered signal. However, RFI emissions associated with the dithered recovered signal may be less than RFI emissions associated with the recovered signal at least resulting from the dithering of the dithered recovered signal.

In at least some examples, the dithering reduces RFI emission associated with the dithered recovered signal by distributing energy of the dithered recovered signal from a nominal frequency to a range of frequencies. In some examples, the dithering is performed without the generation of a high frequency signal (e.g., a signal having a frequency one or more multiples greater than a frequency of the signal provided by the PLL 222, such as about 400 MHz), thereby mitigating issues related to increased RFI emission caused through such generation.

In some examples, the PHY layer 112 performs time stamping, such as for time synchronization (PTP). The time synchronization enables receiving and transmitting devices to synchronize timing, correcting for time and frequency offsets between the transmitting and receiving devices. When the PHY layer 112 operates according to the dithered recovered clock, timestamps applied by the PHY layer 112 may suffer from increased jitter. This increased jitter may degrade accuracy of time synchronization between the PHY layer 112 and the PHY layer 110. To mitigate this challenge, the dithering controller 308 may track a phase offset of the PI 308, as controlled by the dither control signal. By examining this phase offset, a received timestamp in a packet received from the PHY layer 110 may be modified by a same amount as the phase offset to compensate for the dithering performed by the dithering circuitry 116. In some examples, the dithering controller 308 may store the phase offset in a local storage device (not shown) for subsequent access by the MAC layer 108. In other examples, the phase offset may be embedded into a data packet by the digital portion 202 of the PHY layer 112.

FIG. 4 is a block diagram of dithering circuitry 116, in accordance with various examples. In the example of FIG. 4, the dithering circuitry 116 includes the timing loop 302, phase interpolator 304, dithering controller 306, and phase interpolator 308, as described above with respect to FIG. 3. As such, the description of these components is not repeated again herein. The dithering circuitry 116 of FIG. 4 also includes a division circuit 402. In some examples, the division circuit 402 is implemented in the digital portion 202 of the PHY layer 112. In other examples, the division circuit 402 is implemented in the analog portion 204 of the PHY layer 112.

In some devices, it may be useful to have signals available in the device at multiple frequencies. For examples, it may be useful to have signals that function as clock signals in the device available at multiple frequencies. In the context of an Ethernet PHY, for example, an xMII interface may operate at a clock frequency of about 25 MHz and transmission over a transmission medium may occur at a frequency of about 400 MHz. As such, it may be useful to have both 400 MHz and 25 MHz signals available in the circuit. It may be further useful to generate the lower frequency signal (e.g., the 25 MHz signal) from the higher frequency signal (e.g., the 400 MHz signal). One method for generating the lower frequency signal may be dividing the higher frequency signal.

In the example of the dithering circuitry of FIG. 4, the division circuit 402 divides a signal provided by the PI 308 to form a divided dithered signal. In some examples, the division is by a fixed value, where the fixed value is any positive whole number. In an example, the fixed value may be about 16 such that the dithered recovered signal at a frequency of about 400 MHz produces a divided dithered signal at a frequency of about 25 MHz. In other applications, the fixed value may be any other positive whole number, the scope of which is not limited herein. In other examples, the division is by a variable value, where the variable value is any positive whole number and varies with any programmed periodicity, the scope of which is not limited herein.

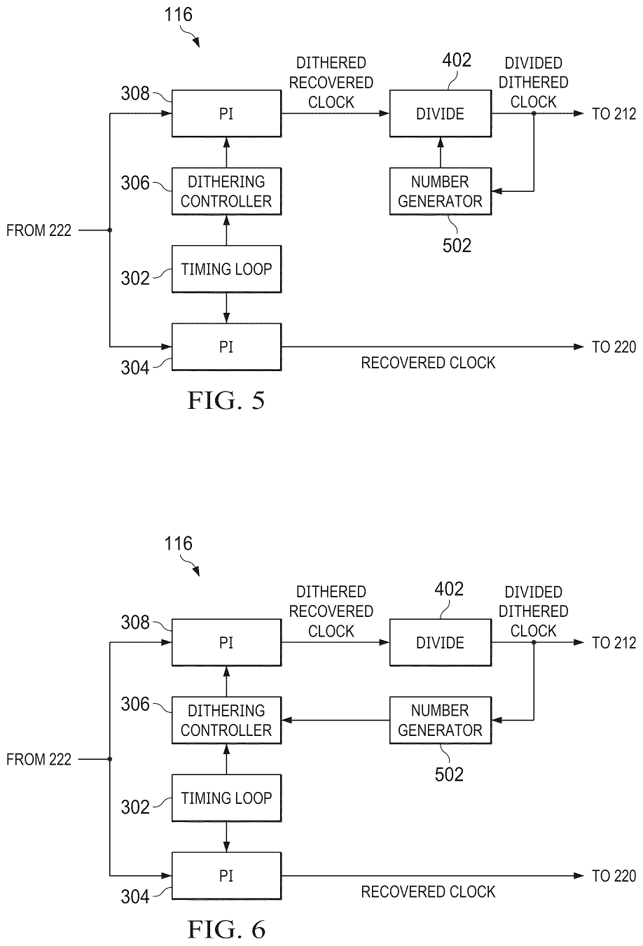

FIG. 5 is a block diagram of dithering circuitry 116, in accordance with various examples. In the example of FIG. 5, the dithering circuitry 116 includes the timing loop 302, phase interpolator 304, dithering controller 306, and phase interpolator 308, as described above with respect to FIG. 3, and the division circuit 402 as described above with respect to FIG. 4. As such, the description of these components is not repeated again herein. The dithering circuitry 116 of FIG. 5 also includes a number generator 502. In an example, the number generator 502 is implemented in the digital portion 202 of the PHY layer 112. In other examples, the number generator 502 is implemented in the analog portion 204 of the PHY layer 112.

In some examples, the divided dithered signal has an approximately 50% duty cycle following division by the division circuit 402. Signals having a 50% duty cycle may have only odd harmonics. As such, an opportunity may exist to further redistribute energy in the divided dithered signal, further reducing RFI emissions associated with the divided dithered signal. For example, by modulating a duty cycle of the divided dithered signal, energy may be redistributed from only the odd harmonics of the divided dithered signal to both the odd and even harmonics of the divided dithered signal. In this way, an overall noise floor of the divided dithered signal is increased at the even harmonics but a peak level of noise at the odd harmonics is decreased. This decrease in noise level at the odd harmonics results in decreased RFI emissions associated with the divided dithered signal.

To modulate the duty cycle of the divided dithered signal the number generator 502 generates a division value. Based on the division value, the division circuit 402 divides the dithered recovered signal to form the divided dithered signal. As described above with respect to the dithered recovered signal, it may be useful for an average duty cycle of the divided dithered signal to remain unchanged from that of the dithered recovered signal. As such, the number generator 502 controls the division circuit 402 to divide the dithered recovered signal to provide divided dithered signals having duty cycles in a range of duty cycles that average to approximately equal the duty cycle of the dithered recovered signal.

In some examples, the number generator 502 provides a random number generated according to any suitable process, the scope of which is not limited herein. In an example, the number generator 502 implements a LFSR based random number generator to generate and provide a random number as the division value. In another example, the number generator 502 implements a Galois Field polynomial number generator to generate and provide a Galois Field polynomial as the division value. The polynomial may be of any suitable order, where a higher polynomial order may result in a reduced peak RFI compared to a lower polynomial order, but may also result in greater drift of the average frequency of the dithered signal from the nominal frequency. In some examples, the number generator 502 generates and provides a plurality of cascaded polynomials having an order between the higher polynomial order and the lower polynomial order may be used to both result in a reduced peak RFI compared to the lower polynomial order while reducing the drift of the average frequency of the dithered signal from the nominal frequency compared to the higher polynomial order.

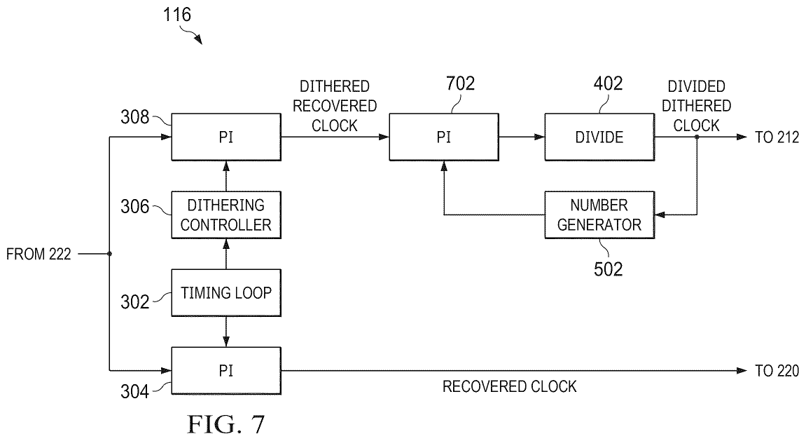

FIG. 6 is a block diagram of dithering circuitry 116, in accordance with various examples. In the example of FIG. 6, the dithering circuitry 116 includes the timing loop 302, phase interpolator 304, dithering controller 306, and phase interpolator 308, as described above with respect to FIG. 3, the division circuit 402, as described above with respect to FIG. 4, and the number generator 502, as described above with respect to FIG. 5. As such, the description of these components is not repeated again herein.

In the dithering circuitry 116 of the example of FIG. 5, in some circumstances, the number generator 502 and division circuit 402 may be limited to performing division according to integer division factors, and therefore performing duty cycle modulation according to the integer division factors. As shown according to the dithering circuitry 116 of FIG. 6, an output signal of the number generator 502 is provided to the dithering controller 306. By providing the division value from the number generator 502 to the dithering controller 306, the dithering controller 306 and the PI 308 may perform the duty cycle modulation in a more granular, or finer resolution, manner. For example, a signal division factor of the dithering circuit 116 of FIG. 5 may be limited to integer value changes in division value. However, a signal division factor of the dithering circuit 116 of FIG. 6 may not be limited to integer values, enabling finer resolution control. In such examples, the dithering controller 306 controls the PI 308 according to both the dither control signal received from the timing loop 302 and the value received from the number generator 502. In this way, the PI 308 both performs dithering by modulating a frequency of the signal received from the PLL 222 in forming the dithered recovered signal, as well as duty cycle modulation by modulating a duty cycle of the signal received from the PLL 222 in forming the dithered recovered signal. As such, RMI associated with the dithered recovered signal may be further reduced as compared to other approaches for forming the dithered recovered signal, based at least on redistributing energy of the dithered recovered signal across both odd and even harmonics within a range of frequencies, as described above with respect to FIGS. 4 and 5.

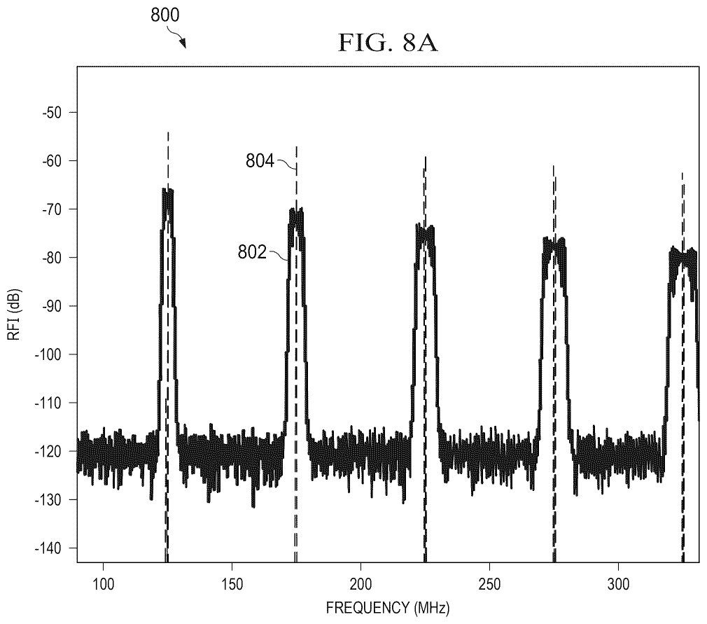

FIG. 7 is a block diagram of dithering circuitry 116, in accordance with various examples. In the example of FIG. 7, the dithering circuitry 116 includes the timing loop 302, phase interpolator 304, dithering controller 306, and phase interpolator 308, as described above with respect to FIG. 3, the division circuit 402, as described above with respect to FIG. 4, and the number generator 502, as described above with respect to FIG. 5. As such, the description of these components is not repeated again herein. The dithering circuitry 116 of FIG. 7 also includes a PI 702.

In the dithering circuitry 116 of the example of FIG. 7, in some circumstances, the PI 308 can form a bottleneck that limits performance of the dithering circuitry 116. For example, the PI 308 may have a maximum update rate. In at least some examples, this maximum update rate is defined at least partially according to a settling time of the PI 308. The maximum update rate may define a maximum rate at which a change in input signal to the PI 308 can modify a value of an output signal of the PI 308. However, in some examples, such as the dithering circuitry 116 of the example of FIG. 6, a dither control signal based at least in part by a division value from the number generator 502, may change in value at a rate greater than supported by the PI 308 according to its maximum update rate. In such examples, dithering and duty cycle modulation functions may be separated between the PI 308 and the PI 702.

For example, the dithering controller 306 controls the PI 308 to perform dithering to form the dithered recovered signal, as described above with respect to FIG. 3. The number generator 502 provides the division value to the PI 702 to control operation of the PI 702. For example, based on the division value, the PI 702 modulates a duty cycle of the dithered recovered signal to redistribute energy of the dithered recovered signal across both odd and even harmonics within a range of frequencies, as described above with respect to FIGS. 4 and 5. By separating operations performed by the PI 308 and the PI 702, a potential problem of exceeding the maximum update rate in the dithering circuitry 116 of the example of FIG. 6 may be mitigated by the dithering circuitry 116 of the example of FIG. 7.

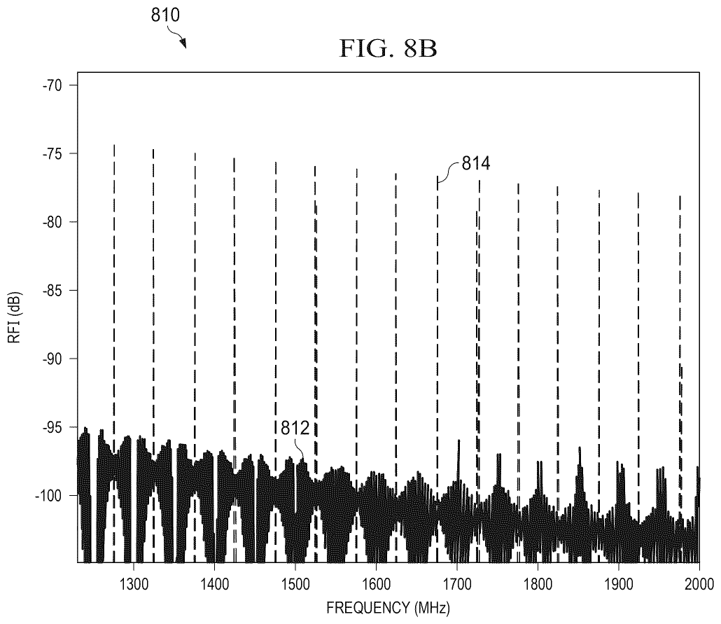

FIGS. 8A and 8B are graphs of performance of the dithering circuitry 116, in accordance with various examples. In an example, FIG. 8A is a graph 800 of RFI 802 in a system including the dithering circuitry 116 of FIG. 3 and RFI 804 in a system not including the dithering circuitry 116 of FIG. 3. Similarly, FIG. 8B is a graph 810 of RFI 812 in a system including the dithering circuitry 116 of FIG. 3 and RFI 814 in a system not including the dithering circuitry 116 of FIG. 3. In both FIGS. 8A and 8B, a horizontal axis is representative of frequency in units of MHz and a vertical axis is representative an amount of RFI in units of decibels (dB). As can be seen in both FIG. 8A and FIG. 8B, implementation of the dithering circuitry 116 of FIG. 3 reduces RFI. This reduction in RFI may render a device including the dithering circuitry 116 of FIG. 3 suitable for an application environment or use case that the device would not be suitable for in the absence of the dithering circuitry 116 of FIG. 3. For example, this reduction in RFI may cause a device including the dithering circuitry 116 of FIG. 3 to be compliant with RFI emission standards for which the device would otherwise be non-compliant in the absence of the dithering circuitry 116 of FIG. 3.

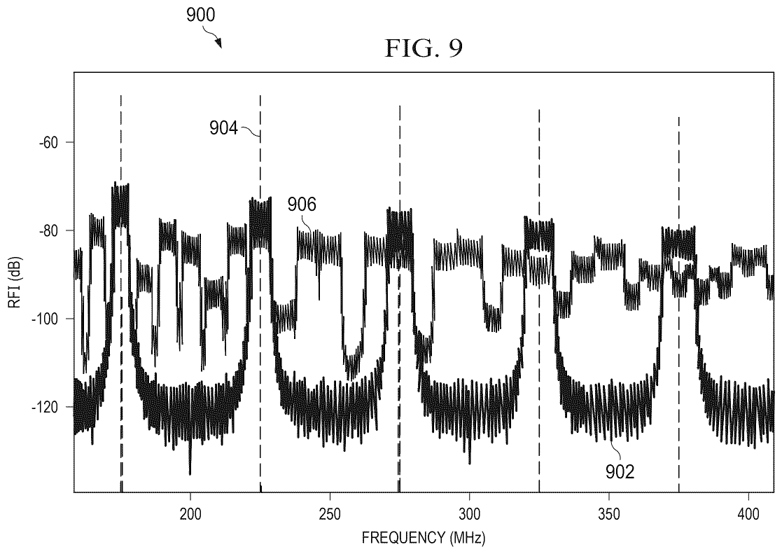

FIG. 9 is a graph of performance of the dithering circuitry 116, in accordance with various examples. In an example, FIG. 9 is a graph 900 of RFI 902 in a system including the dithering circuitry 116 of FIG. 3 and RFI 904 in a system not including the dithering circuitry 116 of FIG. 3, and RFI 906 in a system including the dithering circuit 116 of any one of FIGS. 5-7. In FIG. 9, a horizontal axis is representative of frequency in units of MHz and a vertical axis is representative an amount of RFI in units of dB. As can be seen in FIG. 9, implementation of the dithering circuitry 116 of FIG. 3 reduces RFI. However, the RFI remains concentrated at odd harmonics. Thus, by modifying a duty cycle of the dithered signal, energy may be redistributed from the odd harmonics to both odd and even harmonics, as shown by the RFI 906. As a result, a value of the RFI 906 may be further decreased in comparison to both the RFI 902 and the RFI 904. This reduction in RFI may render a device including the dithering circuitry 116 of one of FIGS. 5-7 suitable for an application environment or use case that the device would not otherwise be suitable for. For example, this reduction in RFI may cause a device including the dithering circuitry 116 of one of FIGS. 5-7 to be compliant with RFI emission standards for which the device would otherwise be non-compliant in the absence of the dithering circuitry 116 one of FIGS. 5-7.

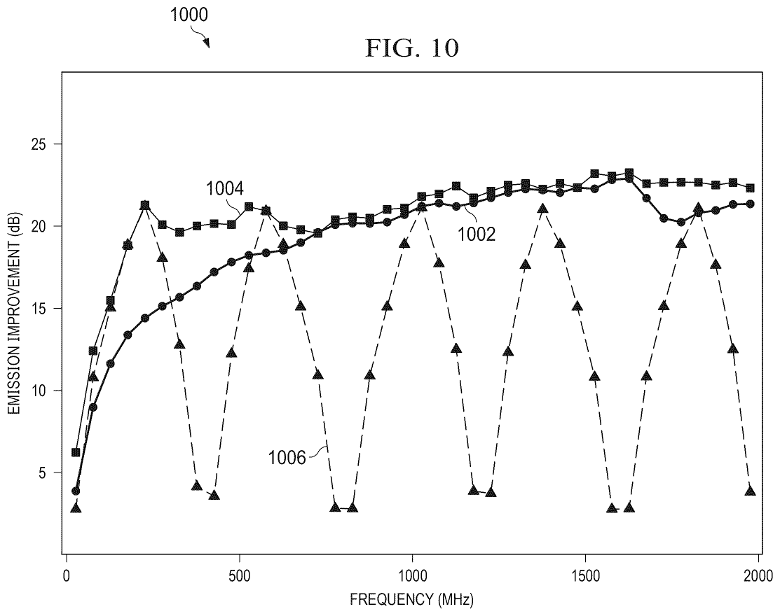

FIG. 10 is a graph of performance of the dithering circuitry 116, in accordance with various examples. In an example, FIG. 10 is a graph 1000 comparing RFI 1002 in a system including the dithering circuitry 116 of FIG. 3, RFI 1004 in a system including the dithering circuitry 116 of one of FIGS. 5-7, and RFI 1006 in a system including the duty cycle modulation of one of FIGS. 4-7 but without dithering. In FIG. 9, a horizontal axis is representative of frequency in units of MHz and a vertical axis is representative an amount of improvement in RFI emission in units of dB. As can be seen in FIG. 10, various approaches result in improvements in RFI emissions under certain circumstances or operational conditions. However, by combining both dithering and modulation of a duty cycle of a recovered signal, increased improvement in RFI emission levels, and therefore increased performance, may be obtained. This reduction in RFI may cause a device including the dithering circuitry 116 of one of FIGS. 5-7 to be compliant with RFI emission standards for which the device would otherwise be non-compliant in the absence of the dithering circuitry 116 one of FIGS. 5-7.

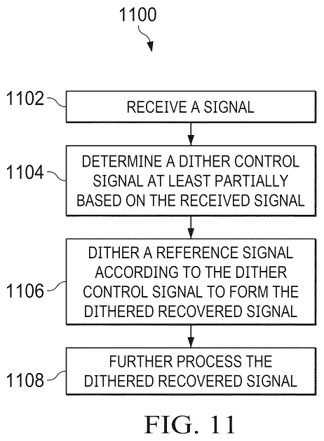

FIG. 11 is a flow diagram of a method 1100 of RFI mitigation, in accordance with various examples. In some examples, the method 1100 is implemented by a PHY layer, such as the PHY layer 112. For example, the method 1100 may be implemented at least in part by dithering circuitry, such as the dithering circuitry 116, described above herein.

At operation 1102, a signal is received. In some examples, the signal is a received from another device (e.g., 102) via a transmission medium (e.g., wired or wireless). The signal may be received in the form of a data packet or data packets. Based on the received signal, timing information may be obtained. The timing information may indicate timing information according to which the data packet was generated (e.g., timing information according to which a component or components forming the data packet were clocked).

Although not shown at operation 1102, in some examples, a separate clock signal is not received, and, instead, a recovered clock signal is derived from timing information associated with the received signal and a locally generated reference signal. For example, the locally generated reference signal may be modified according to the timing information to form the recovered signal having a frequency approximately equal to a frequency indicated by the timing information. In this way, the recovered signal having the frequency approximately equal to a frequency indicated by the timing information may enable processing of the data packet according to the recovered signal to more accurately interpret data contained in the data packet.

At operation 1104, a dither control signal is determined. In some examples, the dither control signal is determined at least in part according to the timing information. The dither control signal may indicate an amount to modulate a frequency of the reference signal to form a dithered signal. Because the modulation is based at least in part on the timing information, the dithered signal may be considered a dithered recovered signal. By modulating the frequency of the reference signal in forming the dithered recovered signal, RFI associated with the dithered recovered signal may be reduced, as described above herein.

Although not shown at operations 1104, in some examples the dither control signal may be further based on other inputs. For example, the dither control signal may be additionally based on a division value. The division value may indicate an amount to modulate a duty cycle of the dithered recovered signal. By modulating the duty cycle of the reference signal in forming the dithered recovered signal, RFI associated with the dithered recovered signal may be further reduced as compared to only modulating the frequency of the reference signal, as described above herein.

At operation 1106, the reference signal is dithered according to the dither control signal to form the dithered recovered signal.

At operation 1108, which is an optional operation step in some examples of the method 1100, the dithered recovered signal may be further processed. In some examples, operation 1108 includes dividing the dithered recovered signal to form a divided dithered signal. In some examples, the dividing is according to a fixed value, as described above herein with respect to FIG. 4. In other examples, the dividing is according to a randomly generated value, such as described above herein with respect to FIG. 5. In some examples, based on the dividing, a division value is determined for use at operation 1104 in providing the dither control signal, as described above herein with respect to FIG. 6. In other examples, based on the dividing, a division value is determined for further processing of the dithered recovered signal, such as to modulate a duty cycle of the dithered recovered signal prior to subsequent division, as described above herein with respect to FIG. 7.

Although not shown in FIG. 11, in some examples, a phase offset associated with the dither control signal is stored. Subsequently, a timestamp associated with a data packet may be modified according to the stored phase offset, such as to increase time synchronization accuracy of the data packet.

In this description, unless otherwise stated, “about,” “approximately” or “substantially” preceding a parameter means being within +/−10 percent of that parameter. Modifications are possible in the described examples, and other examples are possible within the scope of the claims.

Example embodiments of the present disclosure are summarized here. Other embodiments can also be understood from the entirety of the specification and the claims filed herein.

Example 1. An apparatus, including: a transmitting data path configured to transmit an outgoing data packet; and a receiving data path configured to receive an incoming data packet; a controller configured to: determine timing information of the incoming data packet; and dithering circuitry configured to dither a reference signal according to the timing information to vary a frequency of the signal over time to generate a dithered recovered signal.

Example 2. The apparatus of example 1, where the dithering circuitry is configured to modulate a duty cycle of the dithered recovered signal based on the timing information.

Example 3. The apparatus of one of examples 1 or 2, where the dithering circuitry includes: a first phase interpolator configured to generate the dithered recovered signal; and a second phase interpolator configured to generate a recovered clock signal according to the timing information.

Example 4. The apparatus of one of examples 1 to 3, where the dithering circuitry includes: a first phase interpolator configured to generate the dithered recovered signal; and a second phase interpolator configured to modulate the duty cycle of the dithered recovered clock.

Example 5. The apparatus of one of examples 1 to 4, where the dithering circuitry is configured to dither the clock signal by modifying a frequency of the clock signal to be within a range of frequencies having an average frequency over a period of time equal to a frequency of the reference signal.

Example 6. The apparatus of one of examples 1 to 5, where the dithering circuitry is configured to: generate a random number; and modulate a duty cycle of the dithered recovered signal based on the random number.

Example 7. The apparatus of one of examples 1 to 6, where the dithering circuitry is configured to divide the dithered recovered signal to form a divided dithered signal.

Example 8. The apparatus of one of examples 1 to 7, where the dithering circuitry is configured to: generate a random number; and divide the dithered recovered signal according to the random number to form the divided dithered signal.

Example 9. The apparatus of one of examples 1 to 8, where the dithering circuitry is configured to: generate a random number; and dither the reference signal according to the timing information and the random number to generate the dithered recovered signal.

Example 10. The apparatus of one of examples 1 to 9, where the dithering circuitry is configured to generate the random number according to one of a linear feedback shift register or a multi-stage Galois Field polynomial.

Example 11. The apparatus of one of examples 1 to 10, where the dithering circuitry is further configured to: track a phase offset of the dithered recovered signal compared to the recovered signal; and use the phase offset to modify a timestamp of a second incoming data packet.

Example 12. The apparatus of one of examples 1 to 11, where the dithered recovered signal includes multiple signals dispersed in time at multiple frequencies collectively averaging the frequency of the reference signal, and where the dithering causes each of the multiple signals to have a radio frequency interference (RFI) emission value less than that of the reference signal.

Example 13. An integrated circuit, including: a receiving data path configured to receive an incoming data packet; a first phase interpolator configured to generate a recovered clock signal based on a reference signal and according to timing information derived from the incoming data packet; an analog-to-digital converter (ADC) configured to operate based on the recovered clock signal; a second phase interpolator configured to dither the reference signal to generate a dithered clock signal; and a digital core configured to operate based on the dithered clock signal.

Example 14. The integrated circuit of example 13, further including a dithering controller configured to: determine a phase offset of the dithered clock signal; and use the phase offset to modify a timestamp of a second incoming data packet.

Example 15. The integrated circuit of one of examples 13 or 14, further including a media independent interface (MII) configured to connect the integrated circuit to a media access control (MAC) layer.

Example 16. The integrated circuit of one of examples 13 to 15, further including a division circuit configured to: divide dithered clock signal according to a division factor to form a divided dithered clock signal; and control the MII according to the divided dithered clock signal to interact with the MAC layer.

Example 17. A method, including: receiving an incoming data packet on a receiving data path; determining a dither control signal based on timing information of the incoming data packet; dithering a reference signal according to the dither control signal to form a dithered recovered signal; and processing the dithered recovered signal.

Example 18. The method of example 17, further including: determining a phase offset of the dithered recovered signal; and using the phase offset to modify a timestamp of a second incoming data packet.

Example 19. The method of one of examples 17 or 18, further including modulating a duty cycle of the dithered recovered signal.

Example 20. The method of one of examples 17 to 19, where processing the dithered recovered signal includes dividing the dithered recovered signal to form a divided dithered signal.

Example 21. An apparatus including: a transmitting data path configured to transmit an outgoing network packet; and a receiving data path configured to receive an incoming network packet; and a controller configured to: dither a clock signal to vary a frequency of the clock signal over time to generate a dithered clock signal, and modulate one or more properties of the clock signal to synchronize the incoming and outgoing network packets.

Example 22. The apparatus of example 21, where the controller is configured to generate the dithered clock signal based on a recovered clock signal associated with the incoming network packet.

Example 23. The apparatus of one of examples 21 or 22, where the controller includes: a first phase interpolator configured to generate the recovered clock signal; and a second phase interpolator configured to dither the clock signal to generate the dithered clock signal.

Example 24. The apparatus of one of examples 21 to 23, where the controller includes: a first phase interpolator configured to generate the recovered clock signal; and a second phase interpolator configured to reduce a frequency of the recovered clock.

Example 25. The apparatus of one of examples 21 to 24, where the controller is configured to modulate the clock signal by reducing a frequency of the clock signal by one or more factors to result in a lower a number of clock cycles per second.

Example 26. The apparatus of one of examples 21 to 25, where the controller is configured to randomly generate a set of numbers and select the one or more factors from the set of numbers for dividing the frequency of the clock signal.

Example 27. The apparatus of one of examples 21 to 26, where the controller is configured to modulate the clock signal by reducing a duty cycle of the clock signal to reduce a proportion of on time within a complete cycle of the clock signal.

Example 28. The apparatus of one of examples 21 to 27, where the controller is configured to divide the duty cycle by one or more factors included in either one of a fixed pattern of numbers or a randomly generated pattern of numbers.

Example 29. The apparatus of one of examples 21 to 28, where the controller is configured to reduce the duty cycle by fifty percent.

Example 30. The apparatus of one of examples 21 to 29, where the controller is configured to modulate the clock signal by reducing a period of a cycle of the clock signal prior to dithering the clock signal.

Example 31. The apparatus of one of examples 21 to 30, where the controller is further configured to: determine a phase offset of the clock signal; and use the phase offset to modify a timestamp of the incoming network packet.

Example 32. The apparatus of one of examples 21 to 31, where the phase offset is determined prior and subsequent to dithering the clock signal.

Example 33. An integrated circuit including: a receiving data path configured to receive an incoming network packet; a first phase interpolator configured to generate a recovered clock signal; an analog-to-digital converter (ADC) configured to operate based on the recovered clock signal; a second phase interpolator configured to dither the clock signal to generate a dithered clock signal; and a digital core configured to operate based on the dithered clock signal.

Example 34. The integrated circuit of example 33, further including a dithering controller configured to: determine a phase offset of the clock signal; and use the phase offset to modify a timestamp of the incoming network packet.

Example 35. The integrated circuit of one of examples 33 or 34, further including a media independent interface (MII) configured to connect the integrated circuit to a media access control (MAC) layer.

Example 36. The integrated circuit of one of examples 33 to 35, where the MII is configured to provide the dithered signal to the MAC layer.

Example 37. A method including: transmitting an outgoing network packet on a transmitting data path; and receiving an incoming network packet data path on a receiving data path; dithering a clock signal to vary a frequency of the clock signal over time; and modulating one or more properties of the clock signal to synchronize the incoming and outgoing network packets.

Example 38. The method of example 37, further including: determining a phase offset of the clock signal; and using the phase offset to modify a timestamp of the incoming network packet.

Example 39. The method of one of examples 37 or 38, further including generating the dithered clock signal based on a recovered clock signal associated with the incoming network packet.

Example 40. A computer program product including a computer-readable storage medium having computer-readable program code embodied therewith, the computer-readable program code configured to be executed by a controller configured to: transmit an outgoing network packet on a transmitting data path; receive an incoming network packet data path on a receiving data path; dither a clock signal to vary a frequency of the clock signal over time; and modulate one or more properties of the clock signal to synchronize the incoming and outgoing network packets.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An apparatus, comprising:
a transmitting data path configured to transmit an outgoing data packet; and
a receiving data path configured to receive an incoming data packet;
a controller configured to determine timing information of the incoming data packet; and
dithering circuitry configured to dither a reference signal according to the timing information to vary a frequency of the signal over time to generate a dithered recovered signal.

2. The apparatus of claim 1, wherein the dithering circuitry is configured to modulate a duty cycle of the dithered recovered signal based on the timing information.

3. The apparatus of claim 2, wherein the dithering circuitry includes:
a first phase interpolator configured to generate the dithered recovered signal; and
a second phase interpolator configured to generate a recovered clock signal according to the timing information.

4. The apparatus of claim 2, wherein the dithering circuitry includes:
a first phase interpolator configured to generate the dithered recovered signal; and
a second phase interpolator configured to modulate the duty cycle of the dithered recovered clock.

5. The apparatus of claim 1, wherein the dithering circuitry is configured to dither the clock signal by modifying a frequency of the clock signal to be within a range of frequencies having an average frequency over a period of time equal to a frequency of the reference signal.

6. The apparatus of claim 5, wherein the dithering circuitry is configured to:
generate a random number; and
modulate a duty cycle of the dithered recovered signal based on the random number.

7. The apparatus of claim 5, wherein the dithering circuitry is configured to divide the dithered recovered signal to form a divided dithered signal.

8. The apparatus of claim 7, wherein the dithering circuitry is configured to:
generate a random number; and
divide the dithered recovered signal according to the random number to form the divided dithered signal.

9. The apparatus of claim 1, wherein the dithering circuitry is configured to:
generate a random number; and
dither the reference signal according to the timing information and the random number to generate the dithered recovered signal.

10. The apparatus of claim 9, wherein the dithering circuitry is configured to generate the random number according to one of a linear feedback shift register or a multi-stage Galois Field polynomial.

11. The apparatus of claim 1, wherein the dithering circuitry is further configured to:
track a phase offset of the dithered recovered signal compared to the recovered signal; and
use the phase offset to modify a timestamp of a second incoming data packet.

12. The apparatus of claim 1, wherein the dithered recovered signal comprises multiple signals dispersed in time at multiple frequencies collectively averaging the frequency of the reference signal, and wherein the dithering causes each of the multiple signals to have a radio frequency interference (RFI) emission value less than that of the reference signal.

13. An integrated circuit, comprising:
a receiving data path configured to receive an incoming data packet;
a first phase interpolator configured to generate a recovered clock signal based on a reference signal and according to timing information derived from the incoming data packet;
an analog-to-digital converter (ADC) configured to operate based on the recovered clock signal;
a second phase interpolator configured to dither the reference signal to generate a dithered clock signal; and
a digital core configured to operate based on the dithered clock signal.

14. The integrated circuit of claim 13, further comprising a dithering controller configured to:
determine a phase offset of the dithered clock signal; and
use the phase offset to modify a timestamp of a second incoming data packet.

15. The integrated circuit of claim 13, further comprising a media independent interface (MII) configured to connect the integrated circuit to a media access control (MAC) layer.

16. The integrated circuit of claim 15, further comprising a division circuit configured to:
divide dithered clock signal according to a division factor to form a divided dithered clock signal; and
control the MII according to the divided dithered clock signal to interact with the MAC layer.

17. A method, comprising:
receiving an incoming data packet on a receiving data path;
determining a dither control signal based on timing information of the incoming data packet;
dithering a reference signal according to the dither control signal to form a dithered recovered signal; and
processing the dithered recovered signal.

18. The method of claim 17, further comprising:
determining a phase offset of the dithered recovered signal; and
using the phase offset to modify a timestamp of a second incoming data packet.

19. The method of claim 17, further comprising modulating a duty cycle of the dithered recovered signal.

20. The method of claim 17, wherein processing the dithered recovered signal includes dividing the dithered recovered signal to form a divided dithered signal.
